(19) United States
(12) Patent Application Publication
(10) Pub. No.: US 2007/0287330 A1
(43) Pub. Date: Dec. 13, 2007

(54) AUDIO JACK

(75) Inventors: Min-Lung Chien, Taipei (TW); Kai-Ray Cheng, Taipei (TW); Jian CHENG, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ADVANCED CONNECTEK INC., Taipei (TW)

(21) Appl. No.: 11/754,306

(22) Filed: May 27, 2007

(30) Foreign Application Priority Data
Jun. 9, 2006 (TW) 95210101

(51) Int. Cl. H01R 13/648

(52) U.S. Cl. 439/607

(57) ABSTRACT

An audio jack including an insulative housing, conductive terminals and a shielding shell is provided. Stripped protrusions are disposed on the two side surfaces of the insulative housing. Trenches are disposed on the two side surfaces of the insulative housing. A notch is formed on each side surface of the shielding shell, and a depressed protrusion is disposed on each side surface of the shielding shell. At least two pins are disposed on each side surface, and between the pins a U-shaped hook is formed by bending inward. A back wing is coplanar with the top surface of the shielding shell and is bent along the top surface to form a back cover. A pair of opposite side ears perpendicular to the back wing joint the depressed protrusions.

### CROSS-REFERENCE TO RELATED APPLICATION

This application claims the priority benefit of Taiwan application serial no. 95210101, filed Jun. 9, 2006. All disclosure of the Taiwan application is incorporated herein by reference.

### BACKGROUND OF THE INVENTION

1. Field of the Invention

The present invention relates to an electrical connector, especially to an audio jack having more stable electromagnetic shielding effect.

2. Description of Related Art

Nowadays, with the development in the electronic information products, the public demand for electronic products has been growing rapidly. An electric connector is used for transmitting signals or power of the electronic information products and is an indispensable part in any electronic information product. A headphone audio socket that can produce sound effects has been widely utilized in all kinds of electronic products and has become the necessary ports for the output and the input of electronic signals in computers, mobile phones and MP3 players. However, in the techniques of the conventional socket connector, there was even no shielding shell disposed in the conventional socket connectors. The connector without a shielding shell would be interfered by the electromagnetic waves emitted from the surroundings and does not have an electromagnetic shielding effect, so that the quality of signal transmission between electronic information products is affected. Even if the socket connector has a shielding shell, the structures of an insulative housing and a shielding shell are more complicated and therefore are more difficult to assemble. Consequently, the complicated structures are disadvantageous for easy assembly and saving manpower. Furthermore, more complicated structures of the insulative housing and the insulative housing are more likely to be damaged during the assembly. The defective fraction is thus raised and the production cost is increased. Moreover, the shielding shell disposed in the connector does not have a satisfactory shielding effect. Hence, in order to overcome the existing defect in the structure of the connector, it is necessary to further improve the structure of the current audio socket connector to overcome the defect in the current techniques.

### SUMMARY OF THE INVENTION

The present invention provides an audio jack. The audio jack is easy to assemble and carry around, elevates the quality of signal transmission and stabilizes the electromagnetic shielding effect.

In order to achieve the foregoing objects, the invention may be implemented with the following technical solution. The audio jack of the present invention includes an insulative housing, a shielding shell and a plurality of conductive terminals. The insulative housing has a top surface, a bottom surface, a front surface, a rear surface and two side surfaces. A round protrusion is disposed on the front surface for matching with a plug connector. An insertion hole is formed in the round protrusion. A stripped protrusion disposed on each of the two sides of the insulative housing contacts with the shielding shell. A trench on the back of the two side surfaces connects the rear surface. A pit is disposed between the stripped protrusion and the trench and near the bottom of the trench. A plurality of channels is disposed in the pit on the rear surface of the insulative housing for the conductive terminals to plug in and fasten on. Two sliding grooves are disposed at the two sides of the insulative housing. A plurality of conductive terminals includes a first terminal, a second terminal, a third terminal and a fourth terminal. The shielding shell includes a top surface and two side surfaces. Two notches are formed on the two side surfaces of the shielding shell for contacting with the stripped protrusions of the insulative housing. Depressed protrusions contacted with the trenches on the side surfaces of the insulative housing are formed on the back ends of the sides by punching. A locking block protruding outward is formed on the inner surface of the depressed protrusion by punching. An inset locking point disposed near the bottom end of the depressed protrusion is protruding inwardly by punching and the inset locking point is fastened with the insulative housing. On the lower end of each of the side surfaces of the shielding shell are disposed at least two pins. Between the two pins a hook is bent inwardly into a U shape. The U-shaped hook is hung on the exterior wall of the groove on the bottom surface of the insulative housing. A back wing is coplanar and connected with the top surface of the shielding shell and is bent to form a back cover. A pair of opposite upright side ears protrudes vertically from the two sides of the back wing. When the back wing is bent to form the back cover, each of the side ears is jointed with the depressed protrusion on each corresponding side. Each of the side ears has a hole locked tightly with the locking block of each of the depressed protrusions, and the locking block and the hole are fastened so as to fix the junction. The audio jack of the invention has simpler structure and is easy to assemble and carry. Meanwhile, the invention saves manpower and has a more stable electromagnetic shielding effect.

In order to make the implementation of the spirit of the present utility model invention and the objects and effects of the invention more comprehensible to people of skill in the art, embodiments accompanied with drawings are described in detail below. Nevertheless, the invention may be implemented in other ways and is not limited to these examples. Hence, all the other embodiments of the invention implemented by those skilled in the art without departing from the spirit of the invention shall be considered the embodiments of equivalent effect as those fallen within the scope of the appended claims.

### BRIEF DESCRIPTION OF THE DRAWINGS

FIG. 1 is an exploded view of one embodiment of the invention.

FIG. 2 is a perspective view of an insulative housing from another angle according to one embodiment of the invention.

FIG. 3 is a perspective view after the assembly according to one embodiment of the invention.

FIG. 4 is a side cross-sectional view when plugs are not matched according to one embodiment of the invention.

FIG. 5 is a side cross-sectional view after plugs are matched according to one embodiment of the invention.

### DESCRIPTION OF EMBODIMENTS

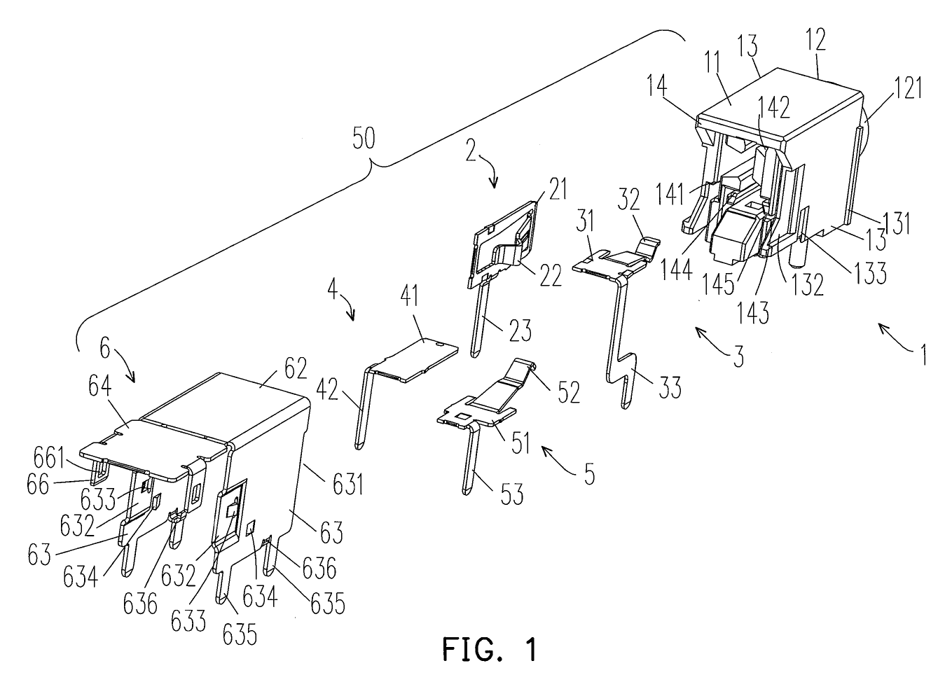

Referring to FIG. 1, it illustrates one embodiment of the audio jack in the present invention. An audio jack 50 includes an insulative housing 1, a first terminal 2, a second terminal 3, a third terminal 4, a fourth terminal 5 plugged therein and a shielding shell 6 assembled with the insulative housing 1.

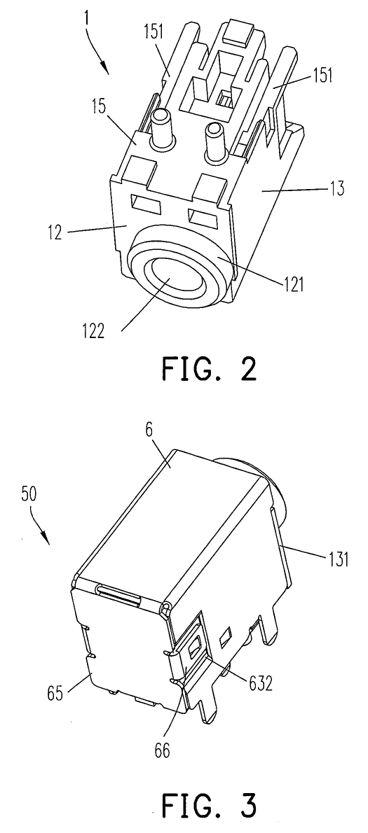

Referring to both FIGS. 1 and 2, the insulative housing 1 has a top surface 11, a bottom surface 15, two side surfaces 13, a front surface 12 and a rear surface 14. A round protrusion 121 is disposed on the front surface 12 for matching with the plug connector. The round protrusion 121 has an insertion hole 122 sunk inwardly from the front surface. The insertion hole 122 penetrates through the insulative housing 1 to the rear surface 14 thereof On the front edge of each of the side surfaces 13 is disposed a stripped protrusion 131 suitable for contacting with the shielding shell 6. On the rear surface of each of the side surfaces 13 is disposed a trench 132 connected with the rear surface 14 of the insulative housing 1. Between the trench 132 and the stripped protrusion 131 and near the bottom of the trench 132 is disposed a pit 133. A plurality of channels is respectively disposed on the rear surface 14 for terminals to plug in. Along the interior wall of the side surface 13 to the bottom surface 15 is formed a groove 141 used for the first terminal 2 to plug and fasten in. On the interior wall of the top surface 11 is disposed a sliding groove 142 and on the interior wall of the other side surface 13 is disposed a groove 143 for the second terminal 3 to plug in. Under the insertion hole 122 is a guiding groove 144 connecting side directions for the third terminal 4 to plug in. Straight beneath the guiding groove 144 is a guiding groove 145 connected with the guiding groove 144. The guiding groove 145 is used for the fourth terminal 5 to plug and fasten in. The contact portion of each of the first terminal 2, the second terminal 3, the fourth terminal 5 plugs in the insertion hole 122 so as to successfully contact the matching plug when the matching plug plugs in. On the both sides of the bottom surface 15 of the insulative housing 1 is disposed a groove 151 for the shielding shell 6 to lock and hook with.

The conductive terminal of the audio jack 50 having a shielding shell in the invention is a plug type. Each of the terminals is integrally formed by a punching process. The fabricating process is briefly described herein. The first terminal 2 has a body 21 and a notch is formed on the body 21 by punching. The rest of the body 21 forms an elastic contact portion 22. A pin 23 protrudes from the bottom surface of the body 21 and is used for plugging in a circuit board. The second terminal 3 includes a horizontal body 31. An elastic contact portion 32 protruding forward is formed on the horizontal body 31 by punching. A pin 33 is formed by bending along the back end of one side surface of the horizontal body 31 and then bending again. The structure of the third terminal 4 is simpler and includes a horizontal body 41 and a pin 42 bent along one side surface of the horizontal body 41. The structures of the fourth terminal 5 and the second terminal 3 are the same, each of which includes a horizontal body 51, an elastic contact portion 52 protruding forward from the horizontal body 51 by punching, and a pin 53 bent along the side of the back end of the horizontal body 51. The third terminal 4 and the fourth terminal 5 form a pair of switch terminals to realize signal transmission of jointed plugs.

The shielding shell 6 has a top surface 62 and two side surfaces 63. A notch 631 is formed at the front edge of each of the side surfaces 63 by cutting and the notch 631 and the stripped protrusion on each side surface of the insulative housing 1 are interfered so as to restrain the shielding shell 6 from moving forward freely. A depressed protrusion 632 is formed at the back end of each of the side surfaces 63 by punching and joints with the trench 132 on each of the side surfaces 13 of the insulative housing 1. A locking block 633 is protruding from inside each of the depressed protrusions 632 by punching. Between the notch 631 and the depressed protrusion 632 and near the bottom of the depressed protrusion 632 is disposed an inset locking point 634. The inset locking point 634 and the pit 133 on the side surfaces 13 are interfered so as to restrain the shielding shell 6 from moving backward freely. At least two pins 635 are extending from the bottom surface of each of the side surfaces 63 downward and suitable for fixing on the circuit board. A U-shaped hook 636 between the two pins 635 is bent inward from the side surfaces. The U-shaped hook 636 is locked and hooked onto the exterior wall of the groove 151 on the bottom surface 15 of the insulative housing 1 so that the shielding shell is prevented from expanding outward and the shielding shell is restrained from moving upward and downward freely. A back wing 64 is coplanar and connected with the top surface 62 of the shielding shell 6, and the back wing 64 may be bent along the top surface 62 to form a back cover 65 covering the back end of the insulative housing 1 (as shown in FIG. 3). A pair of opposite upright side ears 66 protrudes from two sides of the back wing 64 perpendicularly. Each of the side ears has holes 661 for locking with the locking block 633 so that the back cover 65 is solidly fixed with two side surfaces 63.

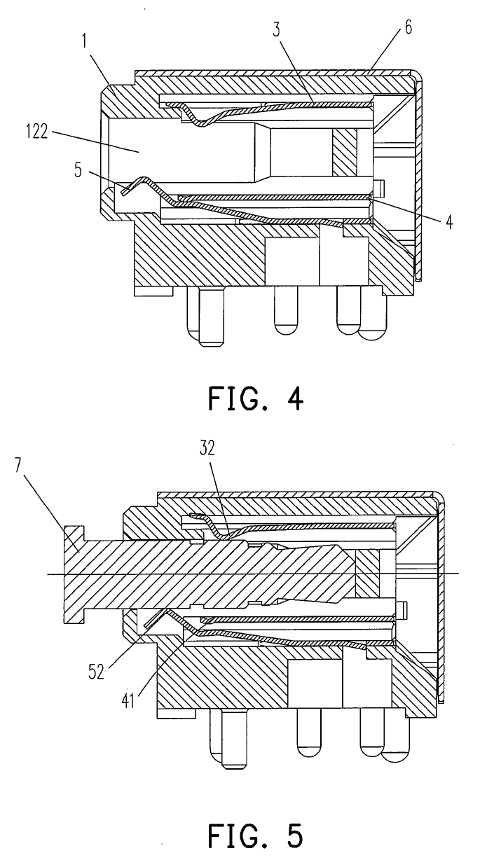

In the audio jack 50 with a shielding shell of the present invention, the first terminal 2, the second terminal 3, the third terminal 4 and the fourth terminal 5 are plugged into corresponding channels from the rear surface 14 of the insulative housing 1. Afterwards, the shielding shell 6 also slides forward from the back end of the insulative housing 1. The U-shaped hook 636 slides along the exterior wall of the groove 151 on the bottom surface 15 of the insulative housing 1. The notches 631 of the shielding shell 6 contact the stripped protrusions 131 of the insulative housing 1. Thus, the shielding shell 6 has been mounted at the correct position in this direction. The depressed protrusions 632 are locked with the trench 132 of the insulative housing 1. The inset locking point 634 is fastened to the pit 133 of the insulative housing 1. Now, the shielding shell 6 is restrained from moving freely both in the vertical and horizontal directions so that the insulative housing 1 and the shielding shell 6 are solidly fastened together. Further, the back wing 64 is forcefully bent along a bend line to form the back cover 65 and the back cover 65 shields the back end of the insulative housing 1 (as shown in FIG. 3). The side ears 66 disposed on the two sides of the back wing 64 are attached to the depressed protrusions 632 of the shielding shell 6 so that the hole 661 and the locking block 633 are locked with each other. Therefore, the back cover 65 cannot open outward and completely shields all the conductive terminals disposed inside the insulative housing 1 to increase the shielding effect of the connector. When a matching plug 7 is not yet plugged into the audio jack 50 (as shown in FIG. 4), the third terminal 4 and the fourth terminal 5 are contacted to form a switch device of the closed-circuit mode. When the matching plug 7 is plugged in (as shown in FIG. 5), the matching plug 7 and the elastic contact portion 52 of the fourth terminal 5 are contacted so that the third terminal 4 and the fourth terminal 5 are separated from each other so as to achieve the transmission of telecommunication signals.

The invention may still be implemented with other alteration and modifications. All the other embodiments implemented by those skilled in the art without departing from the spirit of the invention shall be considered the embodiments of equivalent effect as those fallen within the scope of the appended claims.

What is claimed is:

1. An audio jack, comprising:
a plurality of conductive terminals;
an insulative housing having a top surface, a bottom surface, two side surfaces, a front surface and a rear surface, wherein two stripped protrusions are respectively provided on the side surfaces, trenches and pits are provided on the two side surfaces of the insulative housing, grooves are provided on both sides of the bottom surface, a plurality of channels for accommodating the terminals are provided on the rear surface of the insulative housing;
a shielding shell having a top surface and two side surfaces, wherein depressed protrusions and inset locking points are provided on each of the side surfaces, at least two pins are provided at each of the side surfaces, a U-shaped hook bent inwardly between the pins, a back wing coplanar with and provided on the top surface of the shielding shell is bent along the top surface to form a back cover of the shielding shell, and a pair of opposite upright side ears perpendicular to and provided on the back cover are jointed with the depressed protrusions on the side surfaces of the shielding shell so as to shield the insulative housing.

2. The audio jack as claimed in claim 1, wherein the pit is located between the stripped protrusion and the trench, and near the bottom of the trench on the side surface of the insulative housing.

3. The audio jack as claimed in claim 1, wherein the inset locking point is located between notch of the shielding shell and the depressed protrusion, and near the bottom of the depressed protrusion on each side surface of the shielding shell.

4. The audio jack as claimed in claim 1, wherein a locking block protruding outward is provided on the depressed protrusion by punching and each of the side ears at the two sides of the back wing has a hole so that both the locking block and the hole are formed as a clamping means for fastening and shielding the insulative housing.
